(19) United States
(12) Patent Application Publication
(10) Pub. No.: US 2012/0100260 A1
(43) Pub. Date: Apr. 26, 2012

(54) PET CHEW TOY AND METHOD FOR MAKING THE SAME

(76) Inventor: YI CHIH LIN, Chiayi County (TW)

(21) Appl. No.: 12/909,893

(22) Filed: Oct. 22, 2010

(51) Int. Cl. A23K 1/10; A23P 1/08; A23P 1/10; A23K 1/18

(52) U.S. Cl. 426/92; 426/473; 426/641

(57) ABSTRACT

A method of making a pet chew toy contains steps of: A. processing raw materials, wherein various raw materials are mixed together and ground; B. pressing a mold, wherein the mold is used to press a ground mixer from the step of A, forming a semi-finished product; C. pasting ground meat, wherein at least one fluidic ground meat layer formed by applying the ground meat repeatedly is pasted on an upper and a bottom surfaces of the semi-finished product; D. dehydrating and drying the semi-finished product by heat, wherein the semi-finished product pasted the ground meat layer is heated by a drying machine to eliminate excessive moisture; E. cutting the semi-finished product wrapped by the meat slice to form a finished product, wherein after the semi-finished product pasted the ground meat layer is heated to eliminate excessive moisture, it is cut in a certain shape to form the finished product.

### BACKGROUND OF THE INVENTION

1. Field of the Invention

The present invention relates to a pet chew toy and method for making the same that is capable of enhancing a pet's appetite and to delicious taste of the pet chew toy.

2. Description of the Prior Art

A conventional pet chew toy is made by a method including mixing and grinding various raw materials together or press forming a single raw material.

However, such a conventional pet chew toy still has the following disadvantages:

1. The various raw materials are mixed together that can not attract the pet's appetite.

2. The single raw material is dull that can not enhance delicious taste of the pet chew toy.

3. The pet chew toy can not be made in a vivid appearance and layer manner because the various raw materials are mixed and ground together to have a messy appearance.

The present invention has arisen to mitigate and/or obviate the afore-described disadvantages.

### SUMMARY OF THE INVENTION

The primary object of the present invention is to provide a method of making a pet chew toy that is capable of enhancing a pet's appetite and to delicious taste of the pet chew toy.

Further primary object of the present invention is to provide a method of making a pet chew toy that is capable of bringing out a smell sense of a pet and helping the pet chew the pet chew toy and strengthen and clean the pat's teeth by using its hardness.

Further primary object of the present invention is to provide a method of making a pet chew toy that is capable of pasting various raw materials tightly to increase flexibility.

Also further primary object of the present invention is to provide a method of making a pet chew toy that is capable of simplifying production process to lower production cost.

To obtain the above objectives, a method of making a pet chew toy provided by the present invention contains steps of:

A. processing raw materials, wherein various raw materials are mixed together and then ground;

B. pressing a mold, wherein the mold is used to press a ground mixer from the step of A to form a semi-finished product;

C. pasting ground meat, wherein at least one fluidic ground meat layer formed by applying the ground meat repeatedly is pasted on an upper and a bottom surfaces of the semi-finished product;

D. dehydrating and drying the semi-finished product by heat, wherein the semi-finished product pasted the ground meat layer is heated by a drying machine to eliminate excessive moisture, thereby the ground meat layer is formed a meat slice;

E. cutting the semi-finished product wrapped by the meat slice to form a finished product, wherein after the semi-finished product pasted the ground meat layer is heated to eliminate excessive moisture, it is cut in a certain shape to form the finished product.

A pet chew toy contains:

at least one cowskin layer including a plurality of granule-shaped cowskin grains;

a plurality of ground meat layers, each being formed by applying the ground meat repeatedly, pasted on an upper and a bottom surfaces of the cowskin layer;

wherein the cowskin layer includes a number of granule-shaped meat balls.

### BRIEF DESCRIPTION OF THE DRAWINGS

FIG. 1 is a flow chart of a method of making a pet chew toy according to a first embodiment of the present invention;

FIG. 2 is a flow chart of a method of making a pet chew toy according to a second embodiment of the present invention;

FIG. 3 is a perspective view showing the assembly of a single cowskin layer according to the first embodiment of the present invention;

FIG. 4 is a perspective view showing the assembly of a double cowskin layer according to the first embodiment of the present invention;

FIG. 5 is a perspective view showing the assembly of a single cowskin layer according to the second embodiment of the present invention;

FIG. 6 is a perspective view showing the assembly of a double cowskin layer according to the second embodiment of the present invention;

FIG. 7 is a cross sectional showing the assembly of the double cowskin layer according to the first embodiment of the present invention;

FIG. 8 is a cross sectional view showing the assembly of the double cowskin layer according to the second embodiment of the present invention;

FIG. 9 is a cross sectional view showing the assembly of the double cowskin layer according to the first embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

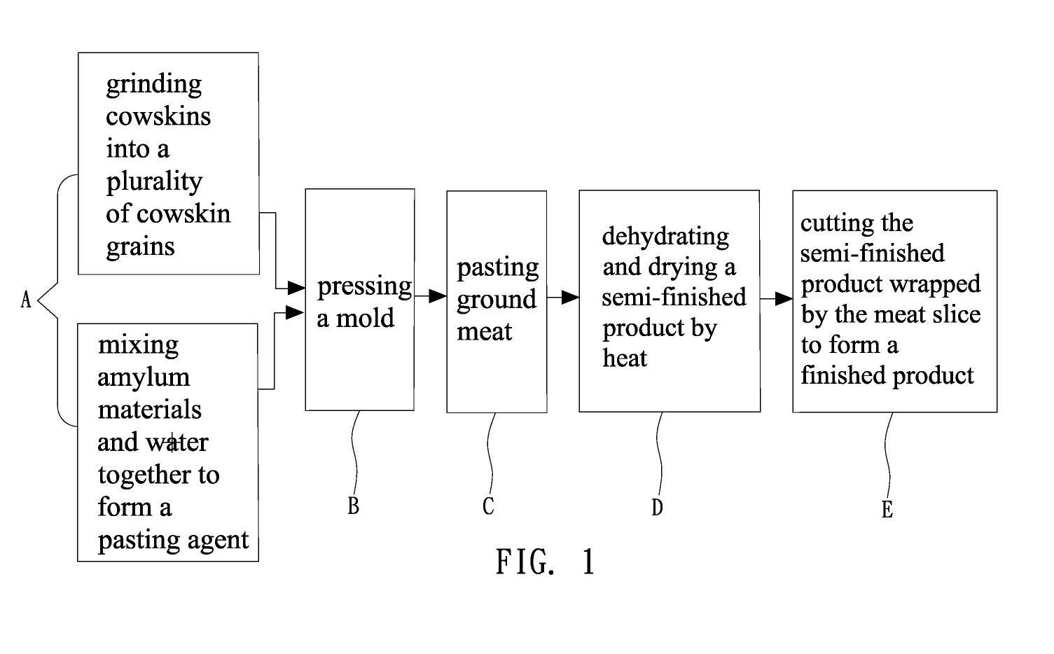

With reference to FIG. 1, a method of making a pet chew toy according to a first embodiment of the present invention comprises steps of:

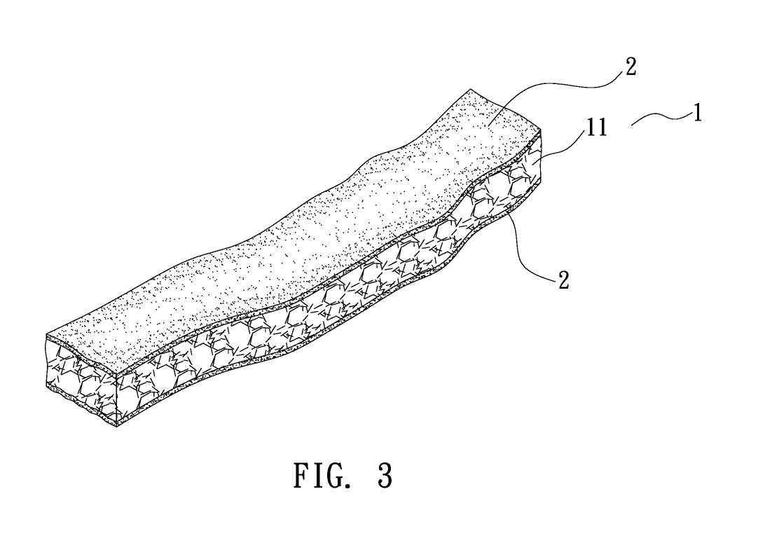

A. processing raw materials, wherein various raw materials are mixed together and then ground, the raw materials include a plurality of cowskins ground and a pasting agent (as shown in FIG. 3), the cowskin is ground into pellets, the pasting agent is comprised of amylum materials and water mixed together;

B. pressing a mold, wherein the mold is used to press a ground mixer from the step of A to form a semi-finished product;

C. pasting ground meat, wherein at least one fluidic ground meat layer 2 (as illustrated in FIG. 3) formed by applying the ground meat repeatedly is pasted on an upper and a bottom surfaces of the semi-finished product, and a thickness of the ground meat layer 2 is decided by a number of times of pasting the ground meat layer to a cowskin layer 1, i.e. the more number of times for pasting the ground meat layer on an outer surface of the cowskin layer 1 is, the thicker the ground meat layer 2 is;

D. dehydrating and drying the semi-finished product by heat, wherein the semi-finished product pasted the ground meat layer 2 is heated by a drying machine to eliminate excessive moisture, thereby the ground meat layer 2 is formed a meat slice;

E. cutting the semi-finished product wrapped by the meat slice to form a finished product, wherein after the semi-finished product pasted the ground meat layer 2 is heated to eliminate excessive moisture, it is cut in a certain shape to form the finished product.

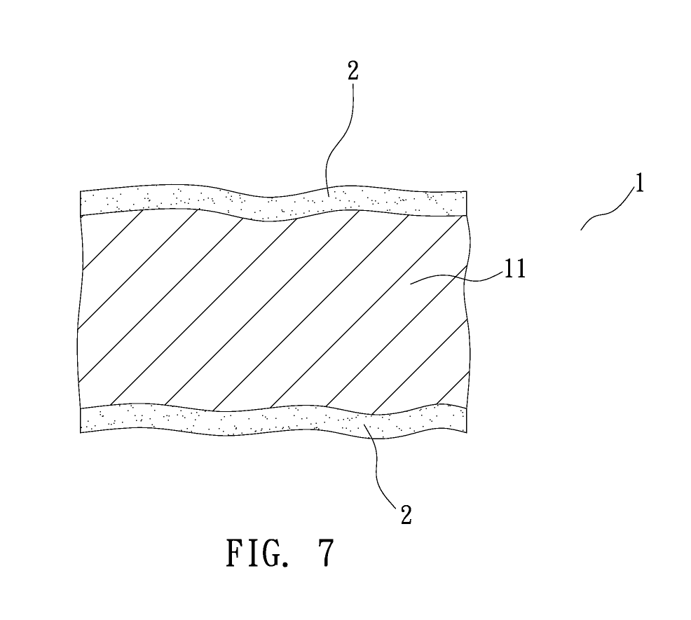

Referring to FIGS. 3 and 7, a single cowskin layer according to the first embodiment of the present invention comprises:

a cowskin layer 1 including a plurality of granule-shaped cowskin grains 11 and a pasting agent, and the cowskin layer 1 is a single layer, the pasting agent includes amylum materials and water mixed together;

two ground meat layers 2, each being formed by applying ground meat repeatedly, pasted on an upper and a bottom surfaces of the cowskin layer 1.

Thereby, the pet chew toy of the first embodiment of the present invention includes the cowskin layer 1 having the two ground meat layers 2 pasted on the upper and the bottom surfaces thereof, and the cowskin layer 1 includes the cowskin grains 11 and the pasting agent adhered with the cowskin grains 11, and the pasting agent includes the amylum materials and the water mixed together.

The ground meat layers 2 are capable of bringing out a smell sense of a pet, and the cowskin layer 1 allows to help the pet chew the pet chew toy and strengthen and clean the pat's teeth by using its hardness.

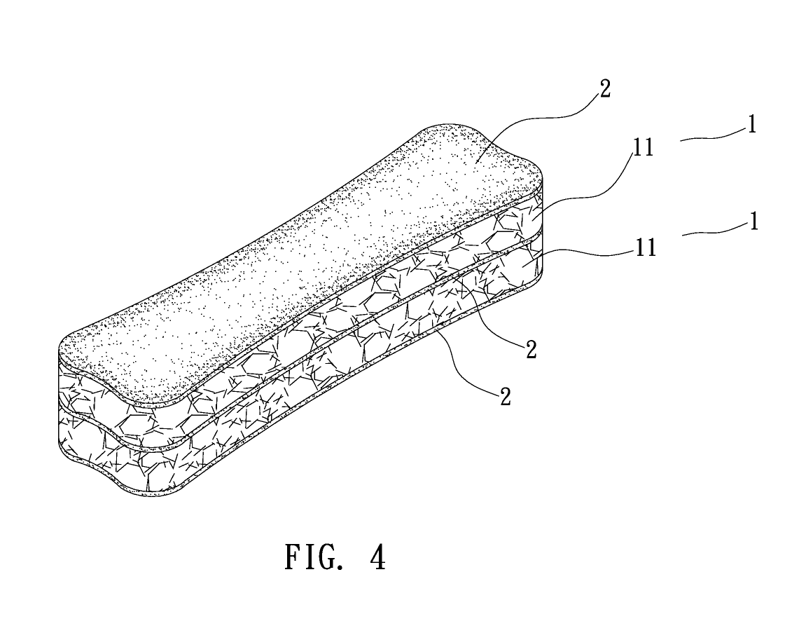

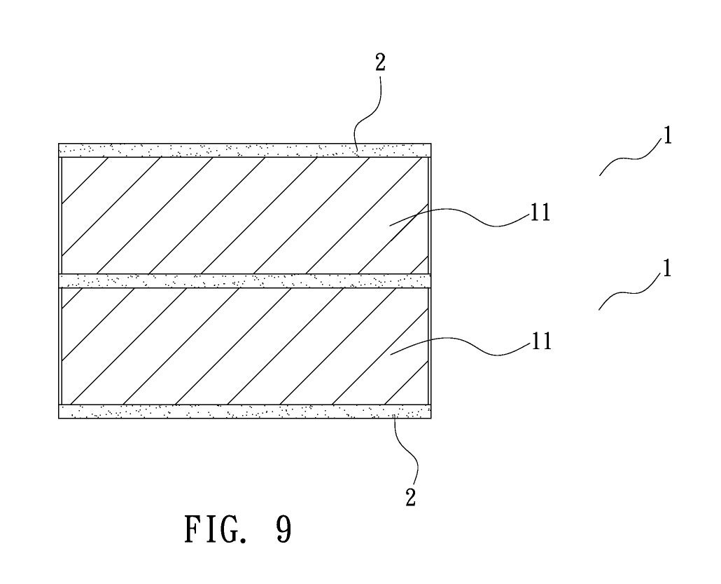

Referring to FIGS. 4 and 9, a double cowskin layer according to the first embodiment of the present invention comprises:

two cowskin layers 1, each including a plurality of granule-shaped cowskin grains 11 and a pasting agent, and the cowskin layer 1 is a double layer, the pasting agent includes amylum materials and water mixed together;

three ground meat layers 2, each being formed by applying the ground meat repeatedly, pasted on an upper and a bottom surfaces of the two cowskin layers 1 respectively.

Thereby, the pet chew toy of the first embodiment of the present invention includes the two cowskin layers 1 having the three ground meat layers 2 pasted on the upper and the bottom surfaces thereof individually, and each cowskin layer 1 includes the cowskin grains 11 and the pasting agent adhered with the cowskin grains 11, the pasting agent includes the amylum materials and the water mixed together.

As shown in FIG. 9, the two cowskin layers 1 are formed among the three ground meat layers 2 to generate a five-layer in order, e.g., the pet chew toy includes the ground meat layer 2, the cowskin layer 1, the ground meat layer 2, the cowskin layer 1, and the ground meat layer 2 arranged vertically in order.

The ground meat layers 2 are capable of bringing out a smell sense of a pet, and the cowskin layers 1 allow helping the pet chew the pet chew toy and strengthening and cleaning the pat's teeth by using its hardness.

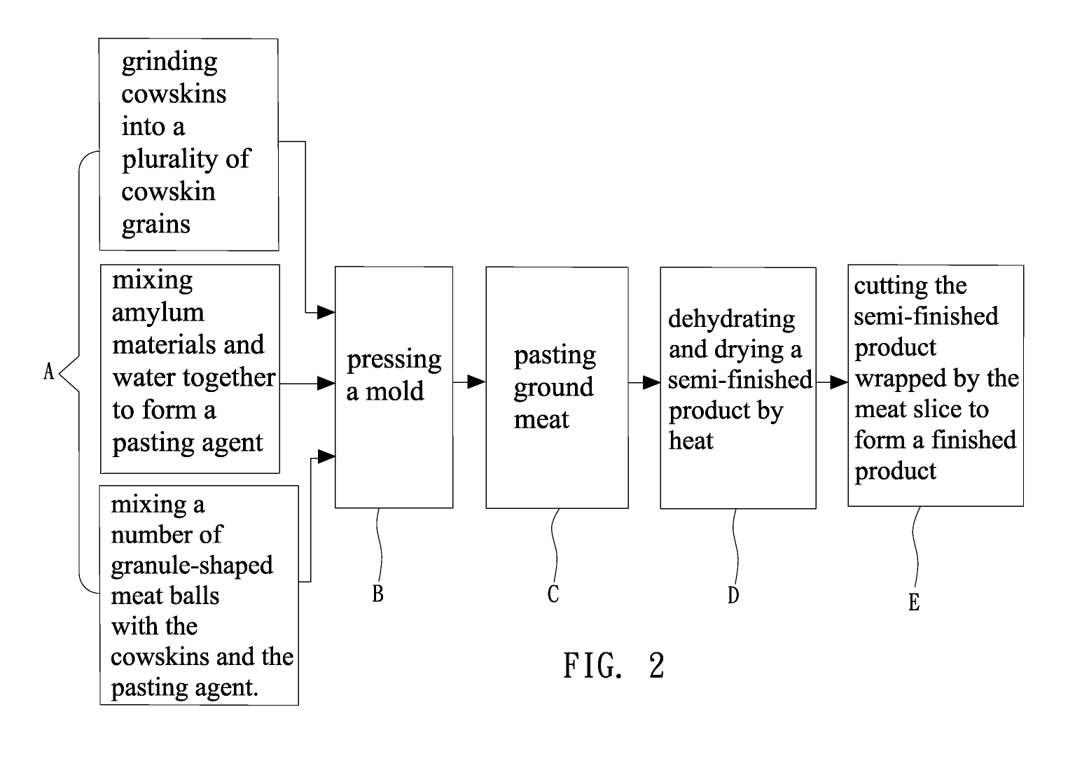

With reference to FIG. 2, a method of making a pet chew toy according to a second embodiment of the present invention comprises steps of:

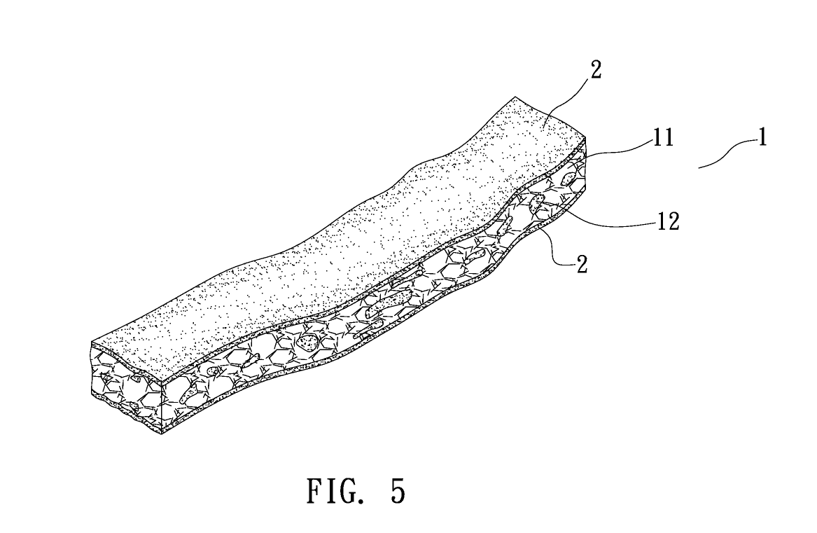

A. processing raw material, wherein various raw materials are mixed together and then ground, the raw materials include a plurality of cowskins ground, a pasting agent, and a number of granule-shaped meat balls 12 (as shown in FIG. 5), the cowskin is ground into pellets, the pasting agent is comprised of amylum materials and water mixed together;

B. pressing a mold, wherein the mold is used to press a ground mixer from the step of A to form a semi-finished product;

C. pasting ground meat, wherein at least one fluidic ground meat layer 2 (as illustrated in FIG. 5) formed by applying the ground meat repeatedly is pasted on an upper and a bottom surfaces of the semi-finished product, and a thickness of the ground meat layer 2 is decided by a number of times of pasting the ground meat layer to a cowskin layer 1, i.e. the more number of times for pasting the ground meat layer on an outer surface of the cowskin layer 1 is, the thicker the ground meat layer 2 is;

D. dehydrating and drying the semi-finished product by heat, wherein the semi-finished product pasted the ground meat layer 2 is heated by a drying machine to eliminate excessive moisture, thereby the ground meat layer 2 is formed a meat slice;

E. cutting the semi-finished product wrapped by the meat slice to form a finished product, wherein after the semi-finished product pasted the ground meat layer 2 is heated to eliminate excessive moisture, it is cut in a certain shape to form the finished product.

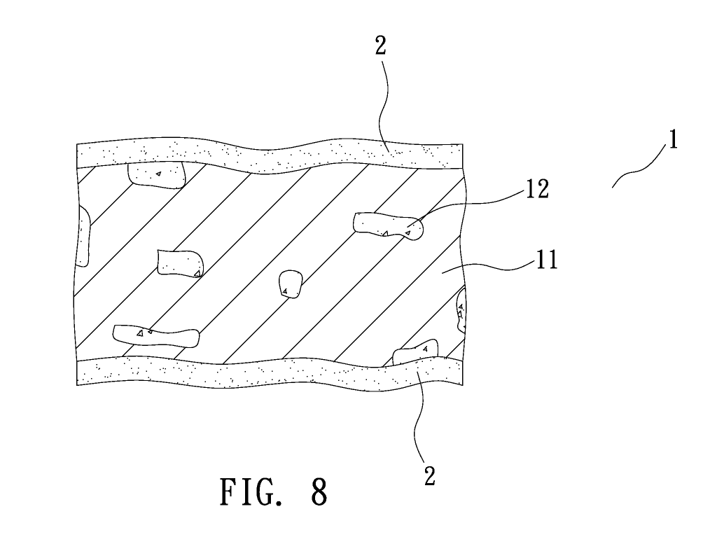

Referring to FIGS. 5 and 8, a single cowskin layer according to the second embodiment of the present invention comprises:

a cowskin layer 1 including a plurality of granule-shaped cowskin grains 11, a pasting agent, and a number of granule-shaped meat balls 12, and the cowskin layer 1 is a single layer, the pasting agent includes amylum materials and water mixed together;

two ground meat layers 2, each being formed by applying the ground meat repeatedly, pasted on an upper and a bottom surfaces of the cowskin layer 1 respectively.

Thereby, the pet chew toy of the second embodiment of the present invention includes the cowskin layer 1 having the two ground meat layers 2 pasted on the upper and the bottom surfaces thereof, and the cowskin layer 1 includes the cowskin grains 11, the pasting agent adhered with the cowskin grains 11, the meat balls 12, and the pasting agent includes the amylum materials and the water mixed together, the meat balls are used to enhance delicious taste of the pet chew toy.

The ground meat layers 2 and the meat balls 12 of the cowskin layers 1 are capable of bringing out a smell sense of a pet, and the cowskin layers 1 allow helping the pet chew the pet chew toy and strengthening and cleaning the pat's teeth by using its hardness.

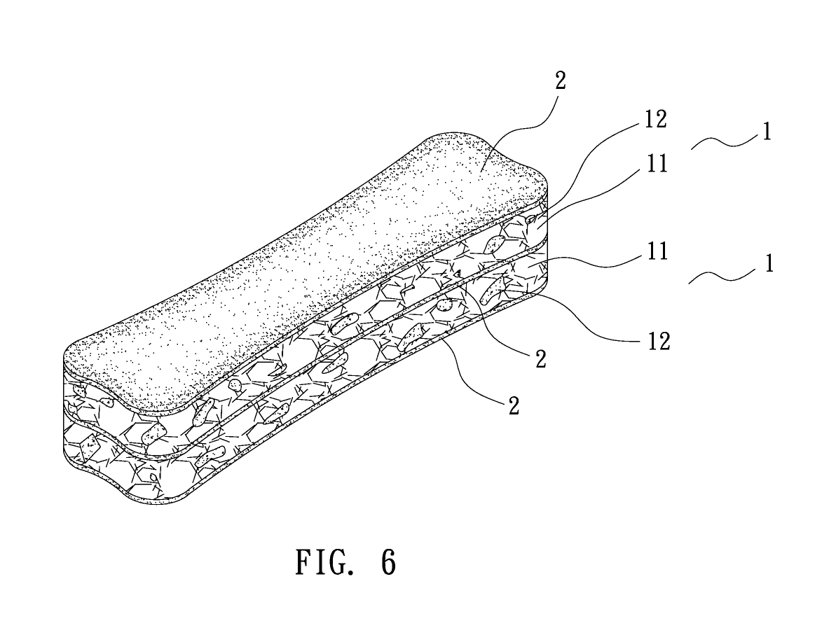

Referring to FIG. 6, a double cowskin layer according to the second embodiment of the present invention comprises:

two cowskin layers 1, each including a plurality of granule-shaped cowskin grains 11, a pasting agent, and a the number of granule-shaped meat balls 12, and the cowskin layer 1 is a double layer, the pasting agent includes amylum materials and water mixed together;

three ground meat layers 2, each being formed by applying the ground meat repeatedly, pasted on an upper and a bottom surfaces of the two cowskin layers 1 respectively.

Thereby, the pet chew toy of the second embodiment of the present invention includes the two cowskin layer 1 having the three ground meat layers 2 pasted on the upper and the bottom surfaces thereof individually, and the cowskin layer 1 includes the cowskin grains 11, the pasting agent adhered with the cowskin grains 11, and the meat balls 12, the pasting agent includes the amylum materials and the water mixed together.

As the pet chew toy of the second embodiment of the present invention is viewed from a cross sectional Figure (not shown), the two cowskin layers 1 are formed among the three ground meat layers 2 to generate a five-layer in order, e.g., the pet chew toy includes the ground meat layer 2, the cowskin layer 1, the ground meat layer 2, the cowskin layer 1, and the ground meat layer 2 arranged vertically in order.

The ground meat layers 2 and the meat balls 12 of the cowskin layers 1 are capable of bringing out a smell sense of a pet, and the cowskin layers 1 allow helping the pet chew the pet chew toy and strengthening and cleaning the pat's teeth by using its hardness.

Thereby, the method of making the pet chew toy includes the steps of: A. processing raw material, B. pressing the mold, C. pasting ground meat, D. dehydrating and drying the semi-finished product by heat, and E. cutting the semi-finished product to form the finished product; and the pet chew toy comprises the al at least one cowskin layer 1 and the ground meat layers 2 formed in a vertical arrangement, wherein the cowskin layer 1 includes the granule-shaped cowskin grains 11, the pasting agent, and the granule-shaped meat balls 12, and the cowskin layer 1 is a single or a double layer, the pasting agent includes the amylum materials and the water mixed together.

While we have shown and described various embodiments in accordance with the present invention, it is clear to those skilled in the art that further embodiments may be made without departing from the scope of the present invention.

What is claimed is:

1. A method of making a pet chew toy comprising steps of:
A. processing raw materials, wherein various raw materials are mixed together and then ground;
B. pressing a mold, wherein the mold is used to press a ground mixer from the step of A to form a semi-finished product;
C. pasting ground meat, wherein at least one fluidic ground meat layer is pasted on an upper and a bottom surfaces of the semi-finished product;
D. dehydrating and drying the semi-finished product by heat, wherein the semi-finished product pasted the ground meat layer is heated by a drying machine to eliminate excessive moisture, thereby the ground meat layer is formed a meat slice;
E. cutting the semi-finished product wrapped by the meat slice to form a finished product, wherein after the semi-finished product pasted the ground meat layer is heated to eliminate excessive moisture, it is cut in a certain shape to form the finished product.

2. The method of making the pet chew toy as claimed in claim 1, wherein the raw materials include a plurality of cowskins ground.

3. The method of making the pet chew toy as claimed in claim 2, wherein the cowskin is ground into pellets.

4. The method of making the pet chew toy as claimed in claim 1, wherein the raw materials include a number of granule-shaped meat balls.

5. The method of making the pet chew toy as claimed in claim 1, wherein the ground meat layer is formed by applying ground meat repeatedly.

6. A pet chew toy comprising:
at least one cowskin layer including a plurality of granule-shaped cowskin grains;
a plurality of ground meat layers, each being formed by applying the ground meat repeatedly, pasted on an upper and a bottom surfaces of the cowskin layer.

7. The pet chew toy as claimed in claim 6, wherein the cowskin layer includes a number of granule-shaped meat balls.
